(19) United States
(12) Patent Application Publication
(10) Pub. No.: US 2026/0181102 A1
(43) Pub. Date: Jun. 25, 2026

(54) XR DISPLAY DEVICE USING EVENT CAMERA FOR DIVERS

(71) Applicant: Korea Electronics Technology Institute, Seongnam-si (KR)

(72) Inventors: Ji Soo HONG, Seoul (KR); Sung Hee HONG, Seoul (KR); Young Min KIM, Seoul (KR); Jin Soo JEONG, Seoul (KR)

(73) Assignee: Korea Electronics Technology Institute, Seongnam-si (KR)

(21) Appl. No.: 19/355,372

(22) Filed: Oct. 10, 2025

(30) Foreign Application Priority Data
Dec. 19, 2024 (KR) 10-2024-0190690

(51) Int. Cl. H04N 7/01; B63C 11/12; G06T 5/50; H04N 23/76

(52) U.S. Cl. CPC H04N 7/0135; B63C 11/12; G06T 5/50; H04N 7/0127; H04N 23/76; B63C 2011/121; G06T 2207/10016; G06T 2207/10024; G06T 2207/20081; G06T 2207/20221

(57) ABSTRACT

Provided is an XR device using an event camera for divers. The XR device according to an embodiment may generate an external RGB image and an external event image by photographing an external environment, may perform video frame interpolation with respect to the external RGB image by using the external event image, and may display the interpolated external RGB image on a transparent display. Accordingly, clearer underwater images may be provided to divers in a low-light underwater environment in which visibility is significantly reduced due to the refraction of water, blurred vision, turbid water, flow of currents.

### CLAIM OF PRIORITY

This application is based on and claims priority under 35 U.S.C. § 119 to Korean Patent Application No. 10-2024-0190690, filed on Dec. 19, 2024, in the Korean Intellectual Property Office, the disclosure of which is herein incorporated by reference in its entirety.

### BACKGROUND

### Field

The disclosure relates to extended reality (XR) application, and more particularly, to an XR device for applying to diving helmets of diving equipment worn by underwater divers.

### Description of Related Art

FIG. 1 is a photo of a diver wearing a related-art diving helmet. This diving helmet provides information to the diver by using a mechanical instrument and a simple display, but has various limitations due to characteristics of the underwater environment.

Specifically, related-art diving helmets are simple in their information providing ways, and require users to continuously pay attentions to check essential data such as oxygen levels, depth, temperature, etc. This may hinder immediate responses in an emergency situation. In addition, due to the lack of effective communication means between divers, cooperation and efficiency of operations may be degraded.

These problems may be addressed by applying XR technology to diving helmets, but use of XR devices underwater may cause problems as follows.

Specifically, visibility is limited underwater due to the refraction and absorption of light, and in particular, the visibility of divers may be significantly reduced at greater depths. In addition, visual information may be distorted or completely blocked by increased turbidity of water from sand, plankton, and the flow of currents.

These problems may threaten divers'safety and may degrade productivity of underwater operations, and hence, there is a need for improvements to compensate for them.

### SUMMARY

The disclosure has been developed in order to solve the above-described problems, and an object of the disclosure is to provide a method for using fusion of a red, green, blue (RGB) camera and an event camera in an XR display to be applied to diver helmets for divers as a solution to generate clearer underwater images in a low-light underwater environment in which visibility is significantly reduced.

According to an embodiment of the disclosure to achieve the above-described object, an XR device may include: an RGB camera configured to generate an external RGB image by photographing an external environment; an event camera configured to generate an external event image by photographing the external environment; an image processor configured to perform video frame interpolation with respect to the external RGB image by using the external event image generated by the event camera; and a transparent display configured to display the external RGB image interpolated by the image processor.

The image processor may interpolate the external RGB image from the external RGB image and the external event image by using a deep learning model that receives an RGB image and an event image and generates intermediate frames of the RGB image. A frame rate of the external event image may be higher than a frame rate of the external RGB image.

The external environment may be a low-light environment. The low-light environment may be an underwater environment. The XR device may be applied to a diving helmet of diving equipment worn by an underwater diver.

The image processor may perform video frame interpolation when an illuminance is less than a threshold illuminance, a water depth is lower than a threshold water depth, or a flow velocity exceeds a threshold flow velocity. The image processor may not perform video frame interpolation and may not operate the event camera when the illuminance is greater than or equal to the threshold illuminance, the water depth is higher than or equal to the threshold water depth, or the flow velocity is less than or equal to the threshold flow velocity.

The image processor may overlap the interpolated RGB image and virtual information, and the transparent display may display the interpolated external RGB image overlapping the virtual information by the image processor.

According to another embodiment of the disclosure, an XR image displaying method may include: generating an external RGB image by photographing an external environment; generating an external event image by photographing the external environment; performing video frame interpolation with respect to the external RGB image by using the external event image; and displaying the interpolated external RGB image on a transparent display.

According to still another embodiment of the disclosure, an image interpolation system may include: a first camera configured to generate a first image by photographing an external environment; a second camera configured to generate a second image that has a higher frame rate than the first image in the external environment by photographing the external environment; and an image processor configured to perform video frame interpolation with respect to the first image by using the second image generated by the second camera.

According to embodiments of the disclosure as described above, in an XR display to be applied to diving helmets for underwater divers, an underwater image generated through an RGB camera may be interpolated with an event image generated by an event camera, so that clearer underwater images may be provided to divers in a low-light underwater environment in which visibility is significantly reduced due to the refraction of water, blurred vision, turbid water, flow of currents.

Other aspects, advantages, and salient features of the invention will become apparent to those skilled in the art from the following detailed description, which, taken in conjunction with the annexed drawings, discloses exemplary embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a photo of a related-art diving helmet;

FIG. 2 is an XR device for underwater divers according to an embodiment;

FIG. 3 is a view illustrating a state in which an RGB camera and an event camera are installed;

FIG. 4 is a view illustrating a method for generating XR images for under divers according to another embodiment of the disclosure; and

FIG. 5 is a view illustrating an XR device for underwater divers according to still another embodiment.

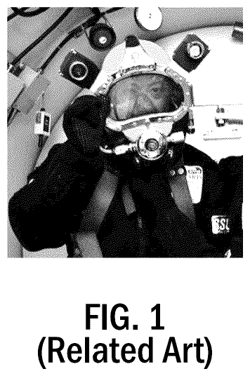

### DETAILED DESCRIPTION

Hereinafter, the disclosure will be described in more detail with reference to the accompanying drawings.

Embodiments of the disclosure propose an XR device for improving clarity of XR images. The disclosure relates to a technique for providing clearer underwater images to divers in a low-light underwater environment in which visibility is significantly reduced, by interpolating an underwater image generated via an RGB camera with an event image generated by an event camera in an XR display to be applied to diving helmets for underwater divers.

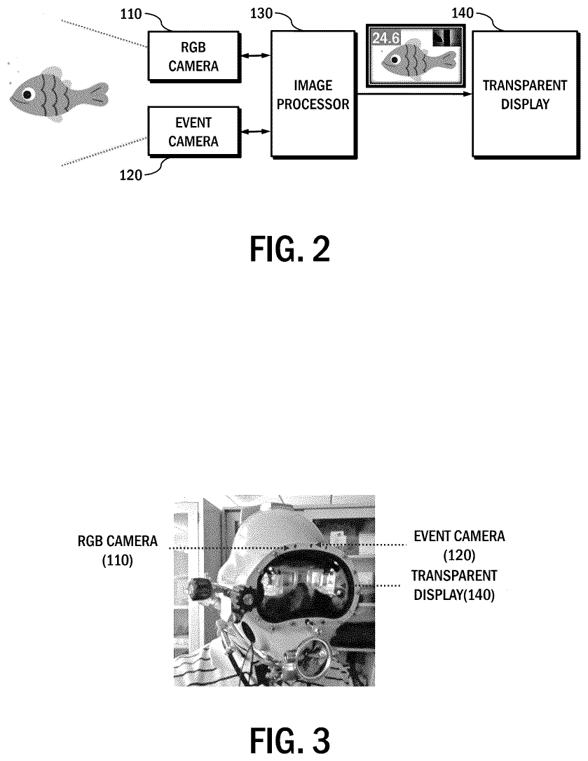

FIG. 2 is a view illustrating a configuration of an XR device for underwater divers according to an embodiment of the disclosure. As shown in FIG. 2, the XR device according to an embodiment may include an RGB camera 110, an event camera 120, an image processor 130, and a transparent display 140.

The RGB camera 110 is a camera that generates an external RGB image by photographing an external underwater environment, and the event camera 120 is a camera that generates an external event image by photographing the external underwater environment.

The event image is an image that results from sensing of only pixels having pixel values changed due to change in brightness or movements. Accordingly, the event image may be generated at high speed since it has very short latency compared to the RGB image, and may be robust even to an extreme light environment due to its wide dynamic range, and hence, the event image may be generated at a high frame rate even in a low-light underwater environment.

As shown in FIG. 3, the RGB camera 110 and the event camera 120 may be installed on an exterior of a diving helmet to face the same view point, so that they generate an RGB image and an event image for the same underwater area.

Reference is made back to FIG. 2. The image processor 130 may set a frame rate of the RGB camera 110 in the low-light underwater environment to be lower than a frame rate in a normal environment, so that the clarity of the external RGB image generated by the RGB camera 110 is improved.

In addition, the image processor 130 may perform video frame interpolation (VFI) with respect to the external RGB image generated by the RGB camera 110 in order to compensate for the reduced frame rate of the external RGB image. The external event image of a high frame rate generated by the event camera 120 may be used for video frame interpolation.

Specifically, video frame interpolation may be performed based on a deep learning algorithm. That is, the image processor 130 may increase the frame rate of the RGB image by using an image interpolation model which is a deep learning model that is trained to predict intermediate frames of an RGB image from the RGB image and an event image.

The image processor 130 may overlap the frame-interpolated RGB image and virtual information. The virtual information to be overlapped may be information that is necessary for underwater divers'dive, and may include a depth, an oxygen level, a compass, a diving route, a performance mission, a central control message, etc.

The transparent display 140 may display the external RGB image overlapping the virtual image by the image processor 130. Since the displayed external RGB image may be generated at a low frame rate and may be interpolated by using the robust event image in the low-light environment, the external RGB image may have improved clarity.

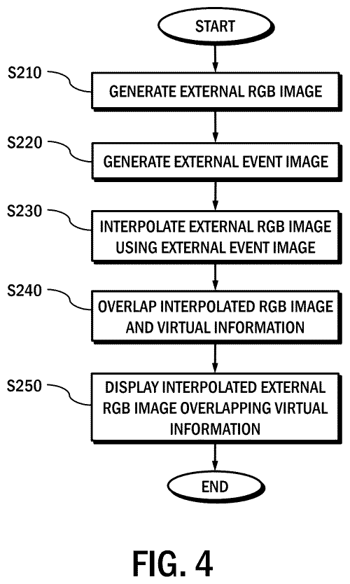

FIG. 4 is a flowchart of a method for displaying XR images for underwater divers according to an embodiment of the disclosure.

In order to display XR images for underwater divers, the RGB camera 110 may generate an external RGB image by photographing an external underwater environment (S210), and the event camera 120 may generate an external event image by photographing the external underwater environment (S220).

The image processor 130 may input the external RGB image generated at step S210 and the external event image generated at step S220 into an image interpolation model to perform video frame interpolation (S230).

The image processor 130 may overlap the interpolated RGB image and virtual information (S240), and the transparent display 140 may display the external RGB image overlapping the virtual image at step S240 (S250).

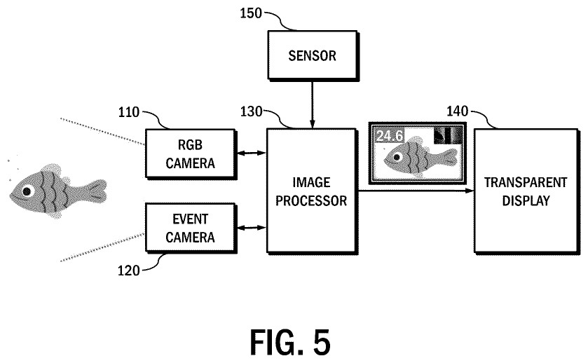

FIG. 5 is a view illustrating a configuration of an XR device for underwater divers according to still another embodiment of the disclosure. The XR device according to an embodiment may be implemented by adding a sensor 150 to the components 110 to 140 of the XR device proposed in FIG. 3 as shown in FIG. 5.

The sensor 150 may include various sensors for measuring an underwater environment, for example, an illuminance sensor, a water depth sensor, a flow velocity sensor, or the like. The water depth sensor may measure a present water depth by measuring water pressure, and the flow velocity sensor is to grasp an intensity of flow of currents. Measurement results of the sensor 150 may be delivered to the image processor 130.

The image processor 130 may control operations of the RGB camera 110 and the event camera 120 based on the measurement results of the sensor 150, and may selectively perform video frame interpolation.

Specifically, when the illuminance is less than a threshold illuminance, the image processor 130 may operate both the RGB camera 110 and the event camera 120, and may perform video frame interpolation with respect to an external RGB image by using an external event image.

When the water depth is lower than a threshold water depth, the image processor 130 may operate both the RGB camera 110 and the event camera 120, and may perform video frame interpolation with respect to an external RGB image by using an external event image. This reflects the fact that, as the water depth is lower, the illuminance is lower.

Furthermore, when the flow velocity exceeds a threshold flow velocity, the image processor 130 may operate both the RGB camera 110 and the event camera 120, and may perform video frame interpolation with respect to an external RGB image by using an external event image. This is because as the flow velocity of currents is faster, the clarity of an RGB image is lower.

On the other hand, when the illuminance is greater than or equal to the threshold illuminance, the water depth is higher than the threshold water depth, and the flow velocity is less than or equal to the threshold flow velocity value, the image processor 130 may operate only the RGB camera 110 and may overlap an external RGB image generated by the RGB camera 110 and virtual information without performing video frame interpolation, and may display the external RGB image on the transparent display 140. This is because the clarity of an external RGB image is not low in such an environment.

Up to now, an XR display device using an event camera for underwater divers has been described with reference to preferred embodiments.

Cameras used in related-art XR technology mostly use RGB cameras alone and have the disadvantage that image quality is degraded in a low-light environment due to various marine contaminants. However, in embodiments of the disclosure, an RGB camera and an event camera are fused and used in a hybrid form to improve image quality even in a low-light environment and various noisy environments.

This overcomes visual limitations caused by the refraction of light, blurred vision, turbid water in the underwater environment, and the display intuitively provides real-time information necessary for operations, such as depths, oxygen levels, compass, thereby greatly improving operation efficiency and safety of divers. Particularly, in emergency situations, the surrounding environment may be quickly analyzed and appropriate routes may be suggested, so that the success rate of rescue operations may be increased, and as a result, the quality and safety of underwater operations may be dramatically improved.

In the above-described embodiments, the RGB camera and the event camera are fused to interpolate an RGB image and provide it as an XR image. However, systems and methods that only interpolate RGB images without generating XR images are also possible, and in this case, the technical idea of the disclosure is still applied.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the present disclosure have been illustrated and described, the present disclosure is not limited to the above-described specific embodiments. Various changes can be made by a person skilled in the at without departing from the scope of the present disclosure claimed in claims, and also, changed embodiments should not be understood as being separate from the technical idea or prospect of the present disclosure.

What is claimed is:

1. An XR device comprising:
an RGB camera configured to generate an external RGB image by photographing an external environment;
an event camera configured to generate an external event image by photographing the external environment;
an image processor configured to perform video frame interpolation with respect to the external RGB image by using the external event image generated by the event camera; and
a transparent display configured to display the external RGB image interpolated by the image processor.

2. The XR device of claim 1, wherein the image processor is configured to interpolate the external RGB image from the external RGB image and the external event image by using a deep learning model that receives an RGB image and an event image and generates intermediate frames of the RGB image.

3. The XR device of claim 2, wherein a frame rate of the external event image is higher than a frame rate of the external RGB image.

4. The XR device of claim 3, wherein the external environment is a low-light environment.

5. The XR device of claim 4, wherein the low-light environment is an underwater environment, and
wherein the XR device is applied to a diving helmet of diving equipment worn by an underwater diver.

6. The XR device of claim 5, wherein the image processor is configured to perform video frame interpolation when an illuminance is less than a threshold illuminance, a water depth is lower than a threshold water depth, or a flow velocity exceeds a threshold flow velocity.

7. The XR device of claim 5, wherein the image processor is configured not to perform video frame interpolation when an illuminance is greater than or equal to a threshold illuminance, a water depth is higher than or equal to a threshold water depth, or a flow velocity is less than or equal to a threshold flow velocity.

8. The XR device of claim 7, wherein the image processor is configured not to operate the event camera when the illuminance is greater than or equal to the threshold illuminance, the water depth is higher than or equal to the threshold water depth, or the flow velocity is less than or equal to the threshold flow velocity.

9. The XR device of claim 1, wherein the image processor is configured to overlap the interpolated RGB image and virtual information, and
wherein the transparent display is configured to display the interpolated external RGB image overlapping the virtual information by the image processor.

10. An XR image displaying method comprising:
generating an external RGB image by photographing an external environment;
generating an external event image by photographing the external environment;
performing video frame interpolation with respect to the external RGB image by using the external event image; and
displaying the interpolated external RGB image on a transparent display.

11. An image interpolation system comprising:
a first camera configured to generate a first image by photographing an external environment;
a second camera configured to generate a second image that has a higher frame rate than the first image in the external environment by photographing the external environment; and
an image processor configured to perform video frame interpolation with respect to the first image by using the second image generated by the second camera.
